(19) United States
(12) Patent Application Publication
(10) Pub. No.: US 2015/0363227 A1
(43) Pub. Date: Dec. 17, 2015

(54) DATA PROCESSING UNIT AND METHOD FOR OPERATING A DATA PROCESSING UNIT

(71) Applicants: YEHEZKEL HEZI RACHAMIM, RAMAT GAN (IL); DORON BEN TZION, RISHON LEZION (IL)

(72) Inventors: YEHEZKEL HEZI RACHAMIM, RAMAT GAN (IL); DORON BEN TZION, RISHON LEZION (IL)

(73) Assignee: FREESCALE SEMICONDUCTOR, INC., Austin, TX (US)

(21) Appl. No.: 14/302,509

(22) Filed: Jun. 12, 2014

(51) Int. Cl. G06F 9/48

(52) U.S. Cl. CPC G06F 9/4831; G06F 9/4881

(57) ABSTRACT

A data processing unit providing a core instruction set wherein the core instruction set comprises a specific core instruction that is adapted to receive data for specifying a hardware component to be called, call the hardware component for executing a job, perform a first context switch that suspends an actual task, wherein the actual task previously called the hardware component using the specific core instruction, perform a second context switch that resumes the actual task when the hardware component finished the job and a method for operating such a data processing unit.

### FIELD OF THE INVENTION

This invention relates to a data processing unit and a method for operating a data processing unit.

### BACKGROUND OF THE INVENTION

In computed environments, some tasks which run on a data processing unit occasionally use hardware components that are not part of the data processing unit's core. A task may use said hardware components to accelerate the overall execution, e.g., the hardware component may perform some operations more quickly than the data processing unit core. Another point may be that the data processing unit is not capable of performing the required operation, e.g., accessing a harddisk for storing/reading data or measuring temperature values.

In real time data processing systems, there might be an extensive use of such hardware components. The hardware components may be external with respect to the data processing unit. Accesses to hardware components are quite common. Accessing a hardware component requires additional clock cycles of the data processing unit because the executed task that accesses the hardware component must wait. Therefore, excessive use of hardware components may slow down the overall execution speed. In this regard, providing additional hardware registers may allow quick suspending of the executed task such that the data processing unit may continue with another task when the hardware component performs the required operation. However, additional hardware registers negatively influence the properties of the data processing unit by increasing power consumption and manufacturing costs.

The U.S. Pat. No. 7,681,022 describes an efficient method for a saving mechanism of an interrupt return address.

The United States Patent application US2005/0033831 A1 describes an advanced processor design comprising a thread aware return address stack optimally used across active threads.

### SUMMARY OF THE INVENTION

The present invention provides a data processing unit and method for operating a data processing unit as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functional similar elements. Elements in the figures are illustrated for simplicity and clarity and have not necessarily been drawn to scale.

FIG. 1 schematically shows an example for a hardware component call from an actual task.

FIG. 2 schematically shows an example for a context switch in combination with a hardware component call.

FIG. 3 shows an example for a code portion representing a function call and a corresponding program stack.

FIG. 4 shows an example of a code portion representing an embodiment of a specific core instruction and a corresponding program stack.

FIG. 5 shows an example of a code portion representing an embodiment of a specific core instruction and a corresponding program stack.

FIG. 6 schematically shows an embodiment of a data processing system.

FIG. 7 schematically shows an example for a core instruction set.

FIG. 8 schematically shows a flow diagram of a method for operating a data processing unit.

### DETAILED DESCRIPTION OF THE PREFERRED EMBODIMENTS

Because the illustrated embodiments of the present invention may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Although the definition of terms hereinafter should not be construed as limiting, the terms as used may be understood to comprise at least the following.

The term “data processing system” may be used for a computer system comprising a data processing unit.

The term “data processing unit” may be used for a microprocessor that may provide a core instruction set. The term “core instruction set” may be used for a set of core instructions implemented on a hardware level of the data processing unit. For example, the core instruction set may comprise machine code or microcode. Machine code may describe an instruction executed directly by the data processing unit, for example in form of circuit-level operations. Microcode may describe a form of adjustable machine code that may, for example, be used for compatibility reasons within a family of data processing units. Within this patent application, machine code and microcode may be represented using pseudo code in assembler like style for illustration.

The term “operand” may be used to describe input values, e.g., input values of a core instruction. For example, an addition of two values requires information about the values that should be added up.

The term “data” may be used to describe any information that may be used as operan for a core instruction of a core instruction set.

The term “receive” may be used to describe that a data value is used as an operand for a specific core instruction.

The term “hardware component” may be used to describe any hardware element that is at least partially separated from the data processing unit. For example, the hardware component may be structurally separated from the data processing unit. A hardware component may, for example, be used to describe a sensor element, an input/output device, a co-processing unit, or any other element of a data processing system that is capable of executing a command/instruction independently from the data processing unit.

The term “program code” may be used for a sequence of machine code instructions. Each program code may define its own “task” that may have a program counter and a specific environment/context. The specific environment may be defined, inter alia, by assigned registers of the data processing unit.

The data processing unit may execute program code, e.g., the sequence of machine code instructions that may represent said computer program. The data processing unit may execute more than one program code and the data processing unit may divide its computational power between executed program codes. Dividing the computational power between running tasks may be realized by switching between them. This may be called a context switch. Switching between two different tasks, e.g., executing a context switch, may comprise suspending a first task and resuming/starting a second task. Suspending and resuming a task may comprise memory operations for storing relevant data defining the tasks context, e.g., the program counter, register values assigned to the task, and task local memory, such as stack and heap memory.

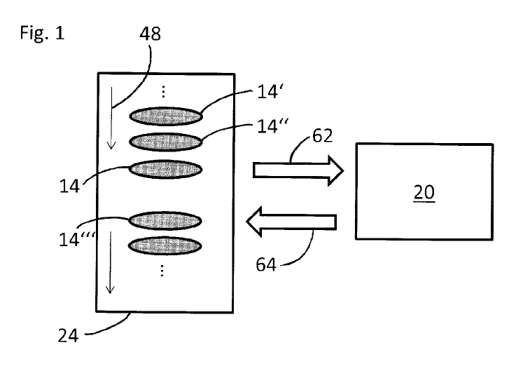

Referring now to FIG. 1 an example for a hardware component call from an actual task is schematically shown. An actual task 24 may comprise a sequence 48 of core instructions 14, 14′, 14″, 14′″. The sequence 48 may define a chronological order for execution of the core instructions 14, 14′, 14″, 14′″. On execution of a specific core instruction 14, a hardware component call 62 may be executed. The hardware component call 62 may call a hardware component for executing a job 20. The hardware component may be external with respect to a data processing unit executing the actual task 24. The execution of the actual task 24 may stop when the job 20 executes because the core instruction 14′″ that is following the specific core instruction 14 may not be executed before the job 20 is finished and a return 64 is given back to the actual task 24. Stopping or suspending the actual task 24 may, for example, be performed by a hardware scheduler that may be at least partially integrated into the data processing unit that executes the actual task 24. Stopping or suspending the actual task 24 may comprise a task switch. The task switch may comprise saving a context of the actual task 24. The context may, for example, comprise assigned register values of the data processing unit and a program stack. Execution of the actual task 24 may be suspended/halted between the hardware component call 62 and the return 64. The return 64 may, for example, comprise a result generated/computed during execution of the job 20. Further, the return 64 may comprise a finishing signal that may, for example, be received by the hardware scheduler. The finishing signal may give the permission to continue execution of the previously stopped or suspended actual task 24. The context of the previously stopped or suspended actual task 24 may be restored before its execution continues, i.e., another context switch may be performed for restoring the context of the actual task 24.

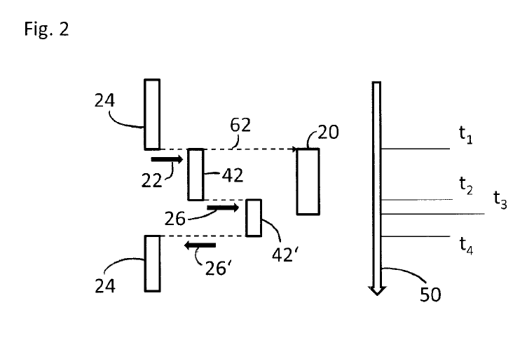

Referring now to FIG. 2, an example for a context switch in combination with a hardware component call is schematically shown. FIG. 2 shows a timeline 50 for execution of tasks on a data processing unit. The actual task 24 may initially be executed by the data processing unit. A first context switch 22 may be executed when a specific core instruction is executed at time t₁. The first context switch may be executed by a hardware scheduler at least partially integrated into the data processing unit. Further, the hardware component call 62 already described in connection with FIG. 1 may occur. The specific core instruction may, for example, initiate execution of the job 20 using said hardware component call 62. The first context switch 22 may suspend the actual task 24. For this purpose, the first context switch 22 may, for example, save a program counter and registers of the data processing unit that are assigned to the actual task 24. The saved program counter and the saved registers may be subsequently used for further execution of the actual task 24 when the actual task 24 is resumed. The first context switch 22 may switch from execution of the actual task 24 to execution of a first new task 42. The first new task 42 may be executed by the data processing unit while the actual task 24 is suspended due to the execution of the job 20 by the called hardware component. The first new task 42 may, for example, comprise its own program stack, program counter, and assigned registers of the data processing unit. A second new task 42′ may start/resume when the first new task 42 ends or becomes suspended. A second context switch 26 may be executed when the first new task 42 ends or becomes suspended. The second context switch 26 may occur at time t₂. At time t₃, the execution of job 20 may finish and execution of currently suspended actual task 24 may continue. A third context switch 26′ may be executed to switch from the second new task 42′ to the actual task 24. The third context switch 26′ may be executed at time t₄. The time t₄ may be defined by time t₃ or by finishing the second new task 42′. That is to say, the time t₄ may be identical with t₃ or, as shown in FIG. 2, may be given by the end of the second new task 42′. Finishing job 20 by the called hardware component may generate a finishing signal causing the third context switch 26′. The finishing signal may, for example, be an interrupt that may be received by the data processing unit and/or the hardware scheduler for further processing. When the third context switch 26′ is executed for resuming the actual task 24, the second new task 42′ may be finished or suspended. The finishing signal may give the hardware scheduler the permission to perform the third context switch 26′. Executing the first new task 42 and the second new task 42′ may accelerate the overall performance of the data processing unit because the data processing unit may continue to work while the first task 24 waits for finishing the job 20. A hardware scheduler may be called for performing the context switch. The hardware scheduler may initiate saving required data/information of the currently running task that shall be suspended, e.g., the actual task, during execution of another task, e.g., the first new task 42 or the second new task 42′. The program counter of a currently running task may be saved to a program stack.

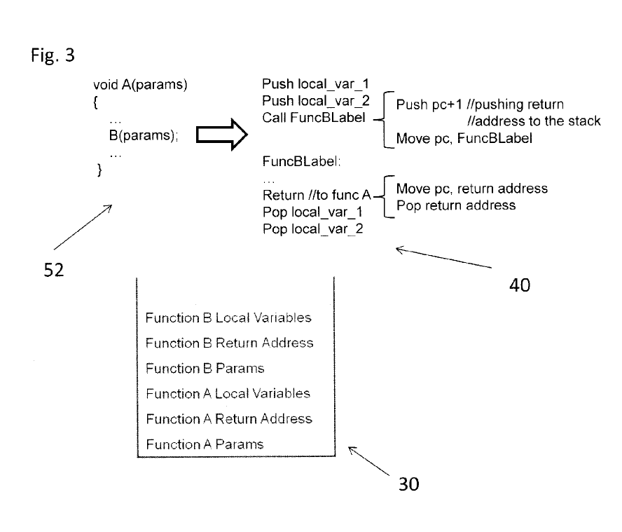

Referring now to FIG. 3, an example for a code portion representing a function call and a corresponding program stack are shown. A code portion 40 may be generated from a listing 52. The listing 52 and the code portion 40 generated thereof may be represented by some kind of pseudo code. The code portion 40 may, for example, represent machine code or microcode by using structures known from assembler language. A program stack 30 may represent a part of a stack memory of a task when executing the code portion 40. Each small box may represent data/instruction stored on the stack using a specific address value. The stack memory or program stack 30 may be organized using the common “last in, first out” principle. It may be possible to push data/instructions on top of the program stack 30, wherein a corresponding stack counter is always pointing to the top. Also it may be possible to pull or pop data/instructions from the top of the program stack 30. The part of the program stack 30 shown in FIG. 3 may be temporarily generated on execution of the code portion 40 by the processing unit. The code portion 40 may, for example, describe that a function A calls a function B. In order to return to the calling function A when the function B is finished, a required return address is stored on the program stack 30. Subsequently, required data/instructions are pushed to the program stack 30. The stack counter may be updated to contain a return address and all other data/information related to function B may be pulled from the stack when function B finishes. The execution of function A may subsequently continue.

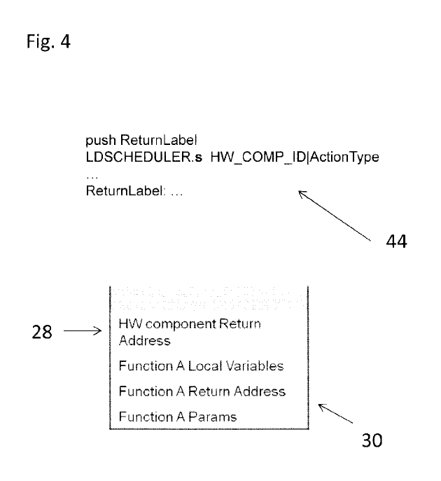

Referring now to FIG. 4, an example of a code portion representing an embodiment of a specific core instruction and a corresponding program stack are shown. A code portion 44 for representing machine code or microcode and a corresponding part of the program stack 30 that may be at least temporarily generated on execution of the program code 44 is shown. The program code 44 may use assembler style pseudo code for representing the machine code or microcode. The code portion 44 may be generated form a listing comprising an instruction having the structure CallAcceleratorX(ActionType, P_ActionData), wherein “ActionType” and “P_ActionData” may be operands of a calling function named CallAcceleratorX. The task may call an accelerator that may be external with respect to the data processing unit when the instruction CallAcceleratorX is reached. This accelerator may, for example, be the hardware component. The calling function CallAcceleratorX may internally use a service routine provided by the data processing unit and seamlessly continue processing the calling task when the accelerator finished the job. Due to the syntax used for the calling function CallAcceleratorX, the calling task (or a programmer writing the program code) may be not aware that using the calling function CallAcceleratorX for calling the accelerator may generate a task switch. The syntax of the calling function CallAcceleratorX may be used similar to a normal function call. Thus the complexity of the program code, the code size, and the complexity of the compiler may be reduced. CallAcceleratorX may require data/information specifying the called accelerator, the required operation and at least a pointer to the data that may be processed as operands. The accelerator type may, for example, be already given by the name CallAcceleratorX, wherein “X” may stand for an accelerator. For example, a cyclic redundancy check accelerator (CRC accelerator) that may perform CRC32 may be called using CallAcceleratorCRC32. The code portion 44 generated from a corresponding program listing comprising the calling function CallAcceleratorX may show a variable return label that may be manually pushed on the program stack 30 before the accelerator is called. The parameters HW_COMP_ID/ActionType may, for example, build a 32 bit register value. Said register value may be passed to and received from the hardware scheduler by using the Ldscheduler.s command to identify the called hardware component and the action to be performed. The Ldscheduler.s command may be implemented as a single core instruction that may be easily accessible, for example, by a single assembler command. Implementing the context switch as a single core instruction may reduce the execution time for a context switch and may, for example, increase the responsiveness of the system. The hardware scheduler may, for example, perform a context switch from the actual task to the first new task and call the named hardware component. This has been already shown in connection with FIG. 2. The suffix “.s” may tell the hardware scheduler to take the return address from the top of the program stack 30 after the hardware component call ended. Said return address may correspond to the variable label that was pushed on the program stack 30 before the hardware component was called. The hardware scheduler may, for example, push the return address in an instruction pointer register. Consequently, the return address may, for example, be manually pushed on the program stack 30 just before a specific core instruction LDSCHEDULER is executed. The hardware scheduler may “pop” the return address from the program stack 30, e.g., the hardware scheduler may increment a stack pointer by a given length such that it points to a return address that shall be used for continuing the actual task, when the job performed by the accelerator is finished. Thus the return address may be used for a further context switch that resumes the previously suspended task. Using the program stack 30 for temporarily saving the return address during the execution of the job does not require a specific register of the data processing unit per suspendable task, e.g., an additional general purpose register or a special register for storing the return address per task. This may save space on the die and may simplify the structure of the data processing unit without restricting its functionality. Nesting of subroutines with hardware components calls may be possible without additional amendments to the data processing unit. Further, nested hardware component calls are easily possible, wherein a first hardware component calls a second hardware component.

The Additionally, HW_COMP_ID may, for example, be used to call another integrated function of the data processing unit that may be independently executed when the data processing unit executes a different task. For example, the HW_COMP_ID may be used for accessing a numeral co-processor. Thus the described syntax may allow using the hardware scheduler like a software based scheduler, e.g., the hardware scheduler may mimic a software based scheduler. The syntax for using the hardware scheduler may be intuitive to the programmer due to its structure that resembles a typical function call. The data processing unit providing the specific core instruction Ldscheduler.s may behave in the same way when a normal function call or a hardware component call using the hardware based scheduler occurs.

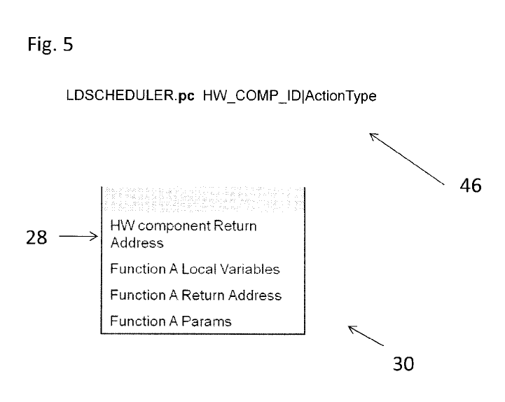

Referring now to FIG. 5, an example of a code portion representing an embodiment of a specific core instruction and a corresponding program stack is shown. A code portion 46 shown in FIG. 5 differs from code portion 44 shown in FIG. 4 by a different suffix “.pc” for the specific core instruction LDSCHEDULER. LDSCHEDULER.s and LDSCHEDULER.pc may describe either different specific core instructions or a single specific core instruction using the suffix as operand. Due to the suffix “.pc”, the hardware scheduler may, for example, push an incremented program counter on the program stack 30 that may be used as the return address 28 on finishing the hardware component call. Incrementing the program counter may, for example, increment the program counter by 1, wherein 1 represents a length of an instruction for the data processing unit.

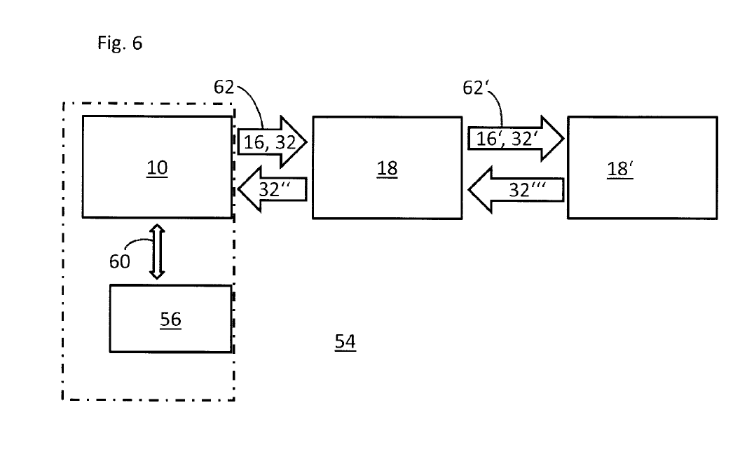

Referring now to FIG. 6, an embodiment of a data processing system is schematically shown. A shown data processing system 54 may comprise a data processing unit 10, a hardware scheduler 56, a hardware component 18 and a further hardware component 18′. The hardware scheduler 56 may be at least partially integrated into the data processing unit 10. This may be indicated using the dashed-dotted box. For example, the hardware scheduler 56 and the data processing unit 10 may be located on a single die or on different dies that are located in a single chip-package. The hardware scheduler 56 and the data processing unit 10 may, for example, interact via a bus 60 that may be an internal or external bus depending on the level of integration. The data processing unit 10 may provide data 16 and/or parameter 32 required for the called hardware component 18. The parameter 32 may be optional. The parameter 32 may, for example, define the job further. For example, the parameter 32 may define whether the job is executed in single precision or double precision.

Due to the hardware scheduler 56 at least supervising calling the hardware component 18, the data 20 and/or the parameter 32 may be transferred to the hardware component 18 via the hardware scheduler 56 or directly from the data processing unit 10. The hardware component 18 may execute a job specified by the data 16 and/or the parameter 32. Optionally, the hardware component 18 may call the further hardware component 18′ using a further hardware component call 62′. The hardware component 18 may provide further data 16′ and further parameter 32′ that are required for the further hardware component 18′. The hardware component 18′ may execute a further job based on the further data 16′ and the further parameter 32′. The further hardware component 18′ may return a result 32′ based on the further data 16′ and the further parameter 32′ back to the hardware component 18 when the further job is finished. The hardware component 18 may return a result 32″ based on the data 16 and the parameter 32, and optionally the result 32′″ when finishing the job. The result 32″ may comprise a signal indicating the data processing unit 10 that the hardware component 18 finished the job. Said signal may be directly transferred to the hardware scheduler 56 for further processing, e.g., resuming a suspended task that called the hardware component 18. The hardware component 18 and/or the further hardware component 18′ may, for example, be at least partially integrated into the data processing unit 10. This integration may be analogously to the integration of the hardware scheduler 56 into the data processing unit 10. However, it may be possible that the hardware component 18 and/or the further hardware component 18′ are external components of the data processing system 54 comprising the data processing unit 10 such that the hardware component 18 and/or the further hardware component 18′ are external components with respect to the data processing unit 10. Thus, the data processing unit 10 may provide a core instruction set, as previously described, wherein said core instruction set may comprise said specific core instruction. The provided specific core instruction may receive the data 16 for specifying the hardware component 18 to be called and a job. The specific core instruction may call the hardware component 18 for executing the job by using the hardware scheduler 56. Said hardware scheduler 56 may perform the first context switch that may suspend the actual task, wherein the actual task previously called the hardware component 18 by using the specific core instruction. Further, a second context switch that may resumes the actual task may be performed when the hardware component 18 finished the job, wherein the second context switch is related to the currently suspended actual task.

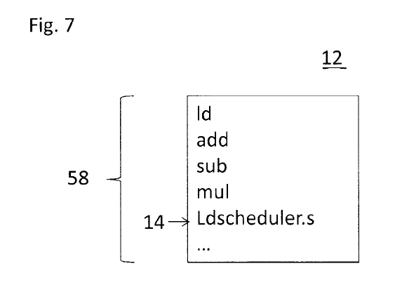

Referring now to FIG. 7, an example for a core instruction set is schematically shown. A core instruction set 12 that may be represented by a few core instructions 58 is partially shown using an assembler like pseudo code for representing single core instructions. For example, the core instruction “Id” may load a given value to a given register. The core instruction “add” may, for example, add the value of a given first register to the value of a given second register, wherein the result is written back to the first register. The core instruction “mul” may, for example, multiply the value of a given first register with the value of a given second register and writing back the result to the given first register. The specific core instruction 14 “Ldscheduler.s” may be part of the core instruction set 58. Another specific core instruction “Ldscheduler.pc” may also be part of the core instruction set 58. The working principle of the specific core instruction 14 “Ldscheduler.s” and/or “Ldscheduler.pc” has been already explained in connection with FIGS. 4 and 5. Providing the specific core instruction 14 “Ldscheduler.s” and/or “Ldscheduler.pc” may provide a generic and fast way for performing a context switch when a hardware component is called for executing a job. Using the specific core instruction may be easily possible due to an uncomplex syntax that resembles simple function calls.

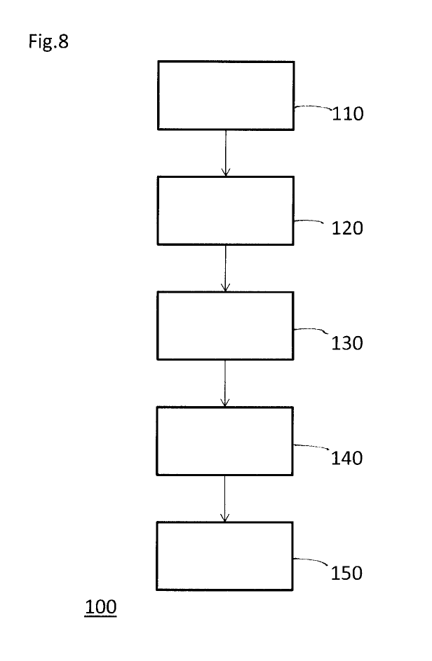

Referring now to FIG. 8, a flow diagram of a method for operating a data processing unit is schematically shown. A method 100 may start at 110. At 110, the data processing unit may execute an actual task. The method 100 may continue at 120. At 120, execution of the actual task may reach a specific core instruction. Said specific core instruction may receive data and/or parameters specifying a hardware component to be called for execution of a specific job, e.g., the data and/or the parameter may be used as operands of the specific core instruction. The called hardware component may execute the job defined by the data and/or the parameter. At 120 said specific core instruction may call the defined hardware component for executing said job. The method 100 may continue at 130. At 130, said specific core instruction may initiate a first context switch that may suspend the actual task that previously called the hardware component using said specific core instruction. The first context switch may, for example, be performed by a hardware scheduler. The hardware scheduler may be at least partially integrated into the data processing unit. Suspending the actual task may, for example, comprise saving a return address on the program stack and saving register values assigned to the actual task. Further, the first context switch may comprise starting a new task or resuming the new task if the new task was already started but temporarily suspended. Restoring/resuming the new task may comprise restoring register values previously saved for the new task and resuming execution of the new task based on a previously saved program counter of the new task that may point to the instruction that should be executed next. The method 100 may continue at 140. At 140, the called hardware component may finish the job. The called hardware component may, for example, indicate finishing the job to the data processing unit by sending a finish signal. The finish signal may, for example, be an interrupt signal. The data processing unit may, for example, receive the finish signal and may, for example, perform a second context switch for resuming the previously suspended actual task. Execution of the second context switch and resuming the actual task may be performed when a currently executed task, for example, the new task or a further new task is finished. Alternatively, the currently executed task, e.g., the new task or the further new task, may be suspended for promptly resuming the actual task. Resuming the actual task may comprise restoring the previously saved register values of the actual task and continuing execution of the actual task at the previously saved program counter. The method 100 may terminate at 150 by further processing the actual task.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

The terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connections that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

The terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the hardware scheduler may be fully or partially integrated into the data processing unit. Also, the hardware component may be fully or partially integrated into the data processing unit.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. For example, the data processing unit may call the hardware component and the hardware component may call a further hardware component and so on.

Also for example, in one embodiment, the illustrated examples may be implemented as circuitry located on a single integrated circuit or within a same device. For example, the hardware component may be a co-processor that is located on the same die and coupled to a core of the data processing unit via an internal bus. Alternatively, the examples may be implemented as any number of separate integrated circuits or separate devices interconnected with each other in a suitable manner. For example, different microprocessors may be located on a single printed circuit board.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

1. A data processing unit providing a core instruction set, wherein the core instruction set comprises a specific core instruction that is adapted to
receive data for specifying a hardware component to be called and a job,
call the hardware component for executing the job,
perform a first context switch that suspends an actual task, wherein the actual task previously called the hardware component using the specific core instruction,
perform a second context switch that resumes the actual task when the hardware component finished the job.

2. The data processing unit according to claim 1, wherein the specific core instruction is further adapted to pop a return address used for the second context switch from a program stack.

3. The data processing unit according to claim 2, wherein the specific core instruction is further adapted to store the return address on the program stack.

4. The data processing unit according to claim 1, wherein the specific core instruction is further adapted to receive at least one parameter for further defining the job.

5. The data processing unit according to claim 1, wherein the first context switch does at least one of starts and resumes at least one new task when the actual task is suspended, and wherein the second context switch suspends the at least one new task when the actual task is resumed.

6. The data processing unit according to claim 1, wherein the second context switch is triggered by a finish signal received from the hardware component.

7. A method for operating a data processing unit providing a core instruction set having a specific core instruction, wherein
the specific core instruction on execution receives data for specifying a hardware component to be called and a job,
the specific core instruction on execution calls the hardware component for executing the job,
the specific core instruction on execution performs a first context switch that suspends an actual task, wherein the actual task previously called the hardware component using the specific core instruction,
the specific core instruction on execution performs a second context switch that resumes the actual task when the hardware component finished the job.

8. The method according to claim 7, wherein the specific core instruction on execution pops a return address used for the second context switch from a program stack.

9. The method according to claim 8, wherein the specific core instruction on execution stores the return address on the program stack.

10. The method according to claim 7, wherein the specific core instruction on execution receives at least one parameter further defining the job.

11. The method according to claim 7, wherein the specific core instruction on execution of the first context switch does at least one of starts and resumes at least one new task when the actual task is suspended, and wherein the specific core instruction on execution of the second context switch suspend the at least one new task when the actual task is resumed.

12. The method according to claim 7, wherein the second context switch is triggered by a finish signal received from the hardware component.

13. The data processing unit according to claim 2, wherein the specific core instruction is further adapted to receive at least one parameter for further defining the job.

14. The data processing unit according to claim 3, wherein the specific core instruction is further adapted to receive at least one parameter for further defining the job.

15. The data processing unit according to claim 2, wherein the second context switch is triggered by a finish signal received from the hardware component.

16. The data processing unit according to claim 3, wherein the second context switch is triggered by a finish signal received from the hardware component.

17. The method according to claim 8, wherein the specific core instruction on execution receives at least one parameter further defining the job.

18. The method according to claim 9, wherein the specific core instruction on execution receives at least one parameter further defining the job.

19. The method according to claim 8, wherein the second context switch is triggered by a finish signal received from the hardware component.

20. The method according to claim 9, wherein the second context switch is triggered by a finish signal received from the hardware component.
